(19) United States
(12) Patent Application Publication
(10) Pub. No.: US 2011/0139618 A1
(43) Pub. Date: Jun. 16, 2011

(54) CERAMIC EXHAUST GAS SENSOR

(75) Inventors: Dana M. Serrels, Davison, MI (US); Ray L. Bloink, Swartz Creek, MI (US)

(73) Assignee: DELPHI TECHNOLOGIES, INC., Troy, MI (US)

(21) Appl. No.: 12/638,337

(22) Filed: Dec. 15, 2009

(51) Int. Cl. G01N 27/407

(52) U.S. Cl. 204/408; 204/426

(57) ABSTRACT

Ceramic exhaust gas sensors are disclosed that offer enhanced dimensional stability during curing, with reduced occurrence of deformations like bending or warping, and can be used in a variety of exhaust gas component sensing applications. The sensors of the invention utilize appropriate selection and orientation of the various layers of green ceramic tape that make up the sensor structure to provide enhanced dimensional stability.

### BACKGROUND OF THE INVENTION

This invention relates to sensors used to detect various constituents (e.g., oxygen, ammonia, hydrogen, nitrogen oxides, carbon monoxide, hydrocarbons, etc.) in combustion exhaust, such as the exhaust from internal combustion engines. Such sensors often include a flat or planar sensing element having multiple ceramic layers that provide for fluid flow on and through the sensor element and on which are disposed various components such as sensing electrodes, ground or reference electrodes, resistors, heater elements, and the like used to detect constituents of interest. Planar ceramic sensor elements are often manufactured by forming a multilayer element of layers of uncured ceramic material known as ceramic tape using known ceramic tape casting methods. Alternative methods may also be used, such as die pressing, roll compaction, stenciling, screen printing and the like. Electrodes and similar components may be disposed onto any of the various layers of ceramic tape before additional layers are placed over the top. Metal to form the electrodes can be applied onto a ceramic layer by known techniques, such as sputtering, vapor deposition, screen printing, or stenciling.

Ceramic layers in exhaust gas sensing elements may be used as solid electrolytes, across which gas ions (e.g., oxygen ions) can move as part of the detection mechanism. Although various materials may function as a solid electrolyte, zirconia (e.g., yttria stabilized zirconia, calcia stabilized zirconia, magnesia stabilized zirconia) is most often used due to its compatibility with extreme environments. Ceramic layers in exhaust gas sensing elements may also be used as dielectric materials to separate various components (i.e., an insulating layer), protect portions of the sensor (i.e., a protective layer), and/or to enhance the structural integrity of the sensing element. Although various materials may function as a dielectric material, alumina (e.g., alpha alumina) is often used due to its compatibility with extreme environments.

After the sensing element, including the various electrodes and other components, is formed from uncured or ‘green’ ceramic layers, the element is cured or hardened by a sintering process in which it is heated to temperatures of 1375° C. to 1575° C. for periods of 1 to 3 hours. During this sintering process, the sensing element may be subject to undesirable physical deformation of the element, which can, in extreme cases, render it unusable. It would therefore be desirable to provide ceramic sensing elements for exhaust gas sensors that could be manufactured using known techniques, but which do not suffer from undesirable physical deformation during sintering.

### SUMMARY OF THE INVENTION

Therefore, according to the present invention, there is provided a flat ceramic exhaust gas sensor comprising a ceramic layer structure including one or more solid electrolyte layers, one or more insulating layers, and two or more electrodes, wherein the ceramic layer structure has:
(a) a flat central layer structure having a top side and a bottom side, said central layer structure selected from the group consisting of
   (1) a single alumina insulating layer;
   (2) two alumina insulating layers of equal thickness;
   (3) a single zirconia layer; and
   (4) two zirconia layers of equal thickness;
(b) on each of the sides of the central layer structure, in order:
   (1) optionally, a first layer structure having a first predetermined thickness, selected from the group consisting of:
      (i) one or more zirconia layers if the central layer structure is one or two zirconia layers;
      (ii) one or more alumina insulating layers if the central layer structure is one or two alumina insulating layers;
   (2) a second layer structure having a second predetermined thickness, selected from the group consisting of:
      (i) one or more zirconia layers if the central layer structure is one or two alumina insulating layers, and
      (ii) one or more alumina insulating layers if the central layer structure is one or two zirconia layers;
   (3) optionally, a third layer structure having a third predetermined thickness, selected from the group consisting of:
      (i) one or more alumina insulating layers if the second layer structure (b)(1) is one or more zirconia layers; and
      (ii) one or more zirconia layers if the second layer structure (b)(1) is one or more alumina insulating layers;
   (3) if the third layer structure is present and is one or more zirconia layers, then optionally, a fourth layer structure having a fourth predetermined thickness, comprising one or more alumina insulating layers; and
   (4) an alumina protective layer having a fifth predetermined thickness.

Ceramic exhaust gas sensors according to the present invention offer enhanced dimensional stability during curing, with reduced occurrence of deformations like bending or warping, and can be used in a variety of exhaust gas component sensing applications.

These and other advantages and features will become more apparent from the following description taken in conjunction with the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is an exploded perspective view of a sensing element according to the invention that can be used for sensing ammonia and/or NOₓ.

FIG. 2 is an exploded perspective view of a sensing element according to the invention that can be used for sensing ammonia and/or NOₓ.

FIG. 3 is an exploded perspective view of a sensing element according to the invention that can be used for sensing oxygen.

FIG. 4 is an exploded perspective view of a sensing element according to the invention that can be used for sensing oxygen.

FIG. 5 is an exploded perspective view of a sensing element according to the invention that can be used for sensing oxygen.

FIG. 6 is an exploded perspective view of a ceramic layer structure that can be utilized in exhaust gas sensor elements according to the invention.

FIG. 7 is an exploded perspective view of a ceramic layer structure that can be utilized in exhaust gas sensor elements according to the invention.

FIG. 8 is an exploded perspective view of a ceramic layer structure that can be utilized in exhaust gas sensor elements according to the invention.

FIG. 9 is an exploded perspective view of a ceramic layer structure that can be utilized in exhaust gas sensor elements according to the invention.

FIG. 10 is an exploded perspective view of a ceramic layer structure that can be utilized in exhaust gas sensor elements according to the invention.

FIG. 11 is an exploded perspective view of a ceramic layer structure that can be utilized in exhaust gas sensor elements according to the invention.

FIG. 12 is an exploded perspective view of a ceramic layer structure that can be utilized in exhaust gas sensor elements according to the invention.

FIG. 13 is an exploded perspective view of a ceramic layer structure that can be utilized in exhaust gas sensor elements according to the invention.

FIG. 14 is an exploded perspective view of a prior art sensing element used as in a comparative example.

FIG. 15 is a set of photographic edge views of layered element structures showing a comparison of deformation observed during curing for elements according to FIG. 2 versus prior art elements according to FIG. 14.

### DETAILED DESCRIPTION

Referring now to the Figures, where the invention will be described with reference to specific embodiments, without limiting same.

It should be noted that the terms “first,” “second,” and the like herein do not denote any order or importance, but rather are used to distinguish one element from another, and the terms “a” and “an” herein do not denote a limitation of quantity, but rather denote the presence of at least one of the referenced items. Furthermore, all ranges disclosed herein are inclusive and combinable (e.g., ranges of “up to about 25 weight percent (wt. %), with about 5 wt. % to about 20 wt. % desired, and about 10 wt. % to about 15 wt. % more desired,” are inclusive of the endpoints and all intermediate values of the ranges, e.g., “about 5 wt. % to about 25 wt. %, about 5 wt. % to about 15 wt. %”, etc.).

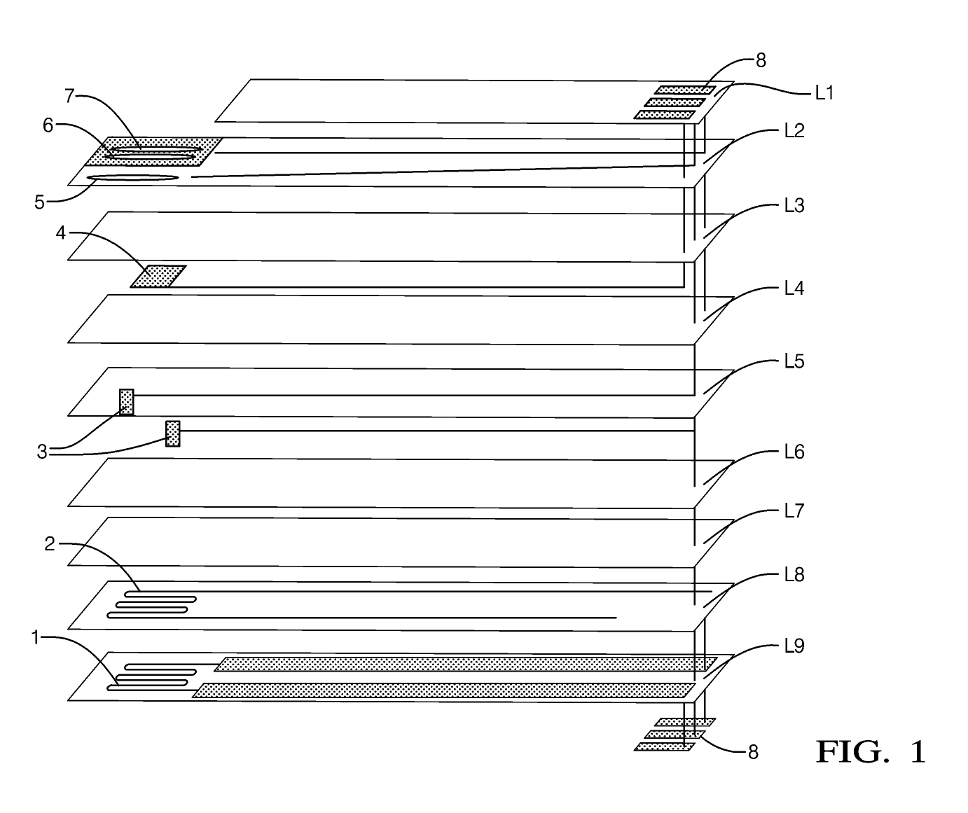

Turning now to FIG. 1, an exploded perspective view is shown of an exemplary embodiment of a sensing element structure according to the invention that can be used for sensing ammonia and/or NOₓ.

Alumina protective layer L9 is configured with a heater element 1 thereon. The heater 1 can be any heater capable of maintaining the sensor end of the ammonia sensor element at a sufficient temperature to enable the sensing of ammonia. The heater 1 can comprise platinum, palladium, tungsten, molybdenum, and the like, or alloys or combinations comprising at least one of the foregoing, or any other heater compatible with the environment. The heater 1 can be printed (e.g., thick film printed) onto the alumina layer a sufficient thickness to attain the desired resistance and heating capability. The heater thickness can be, for example, about 10 micrometers to about 50 micrometers, or so.

Alumina layer L8 is shown configured with EM shield 2, although the shield 2 may be disposed anywhere between the heater 1 and the other components that could be subject to EM interference from the heater 1. The shield 2 can comprise, for example, a closed layer, a line pattern (connected parallel lines, serpentine, and/or the like), and/or the like. The shield 2 can comprise any material capable of enhancing the electrical isolation of the heater from the temperature sensor. Possible shield materials include precious metal (such as platinum (Pt), palladium (Pd), gold (Au) and the like, as well as alloys and combinations comprising at least one of the foregoing materials. Zirconia layer L7 is disposed over alumina layer L8, and alumina insulating layer L6 is disposed over zirconia layer L7.

Zirconia layer L5, which serves as the central layer structure in this embodiment of the invention, is configured with an impedance electrode 3 that functions as a resistance temperature detector to measure temperature on the sensing end of the sensor element. Potential materials for the temperature electrode 3 can be any material having a sufficient temperature coefficient of resistance to enable temperature determinations, and have a sufficient melting point to withstand the co-firing temperature (e.g., of about 1,400 degree. C. or so). Some possible materials include those employed for the heater 1. The temperature sensor can comprise a serpentine portion with a line width of less than or equal to about 0.15 mm. Alumina insulating layer L4 is disposed over zirconia layer L5.

The exhaust component sensing section of the element comprises the ammonia sensing electrode 6 and backing electrode 7, along with NOx sensing electrode 5 disposed on alumina insulating layer in ionic communication with zirconia solid electrolyte layer L3. On the opposite side of solid electrolyte layer L3 from the sensing electrodes is reference electrode 4. The element also has gas flow channels between layers L3 and L4 for reference gas (which in this case is same as the exhaust gas being sensed), and also gas flow channels on each side of layer L5 for enhancing the responsiveness of the temperature sensor. Electrically conductive pads 8 are disposed on the outside of protective layer L1 to be in electrical contact with the sensing electrodes 5 and 6, the reference electrode 4, and one of the impedance electrodes 3 through vias (not shown) in the layers. Electrically conductive pads 9 are disposed on the outside of protective layer L9 to be in electrical contact with the heater element 1 and the other of the impedance electrodes 3 through vias (not shown) in the layers. Alumina protective layer L1 is shown as not extending over the sensing electrodes 5 and 6; however, layer L1 may also include a porous section that can extend over the sensing electrodes. Each of the ceramic layers L1-L9 in FIG. 1 has an identical cured thickness of 172 μm.

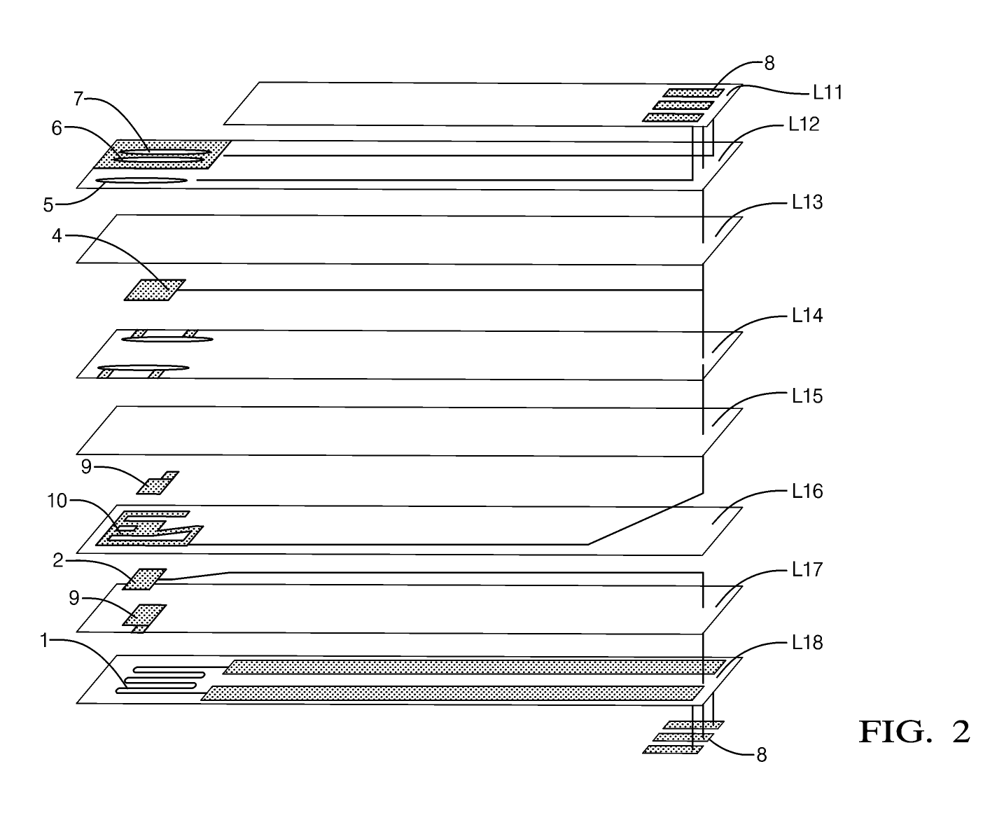

FIG. 2 represents an exploded perspective view of an alternative exemplary embodiment of a sensing element structure according to the invention that can be used for sensing ammonia and/or NOₓ. The electrode structure and function for this element is the same as for FIG. 1. In the structure of FIG. 2, the layer structure is different than that of FIG. 1, with the central structure having two alumina layers L14 and L15, the first layer structure not present, the second layer structure having a single zirconia layer L13, L16 on each side of the central layer structure, the third layer structure having a single alumina layer L12, L17 disposed on each layer of the second layer structure, and the fourth layer structure has a single alumina insulating layer L11, L18 disposed on each layer of the third layer structure. Layers L11 and L18 each represents an alumina protective layer. Each of the layers L11 through L18 has a cured thickness of 172 μm. Layer L13 functions as a solid electrolyte layer by selectively allowing oxygen ions to pass through it during operation. Other components disposed on or between the ceramic layers of the sensing element are as described for FIG. 1.

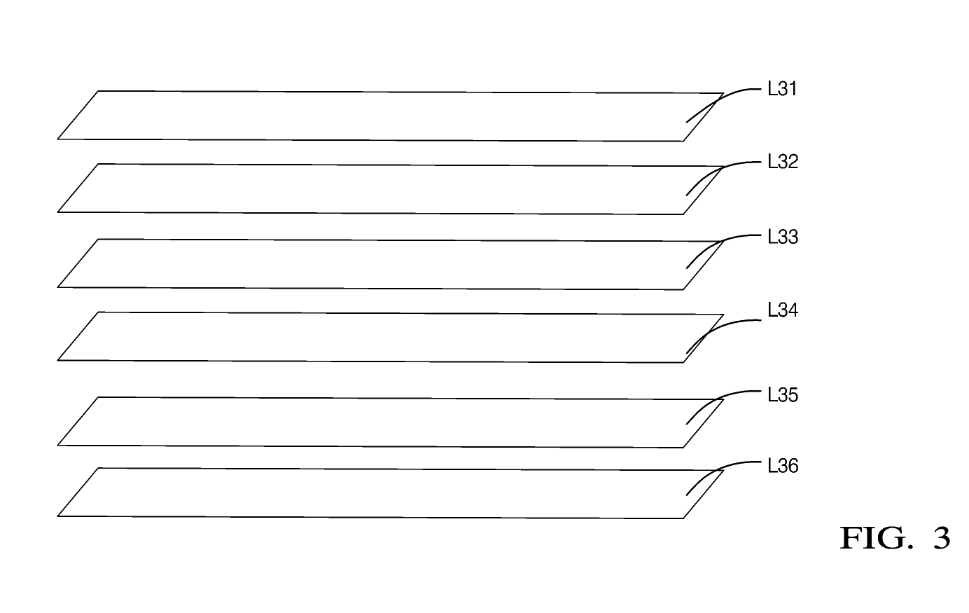

Each of FIGS. 3-13 represents exploded perspective views of exemplary alternative embodiments of ceramic layer structures for exhaust gas sensing elements of the invention. Unlike FIGS. 1-3, components necessary for sensing exhaust gas components (e.g., sensing electrodes, reference electrodes, impedance electrodes, heater elements, and the like) are not shown in these Figures, as one skilled in the art would readily be able to configure the layer arrangements shown in FIGS. 3-13 with such components using design and manufacturing techniques well-known in the art. Accordingly, FIGS. 3-13 show only the ceramic layer structures of such alternative exemplary embodiments.

Ceramic layer structures according to the present invention such as those shown in FIGS. 3, 4, and 5 may be adapted for use in sensing oxygen in combustion exhaust. The principles by which such a sensor operates, along with materials and methods for its manufacture, are described in detail in U.S. Pat. Nos. 5,384,030, 6,555,159, 6,572,747, and 7,244,316, the disclosures of which are incorporated herein in their entirety. Turning now to FIG. 3, in this exemplary embodiment, the central layer structure has two alumina insulating layers L33 and L34, the first layer structure is not present, the second layer structure has a single zirconia layer L32, L35 on each side of the central layer structure, and the third and fourth layer structures are not present. Layers L31 and L36 each represents an alumina protective layer. Each of layers L31 through L36 has an identical thickness of 172 micrometers. Layer L32 functions as a solid electrolyte layer by selectively allowing oxygen ions to pass through it during operation. In one exemplary embodiment when used as an oxygen sensor, the element of FIG. 3 would have a sensing electrode on top of layer L32, a reference electrode between layers L32 and L33, and a heater element between layers L33 and L34.

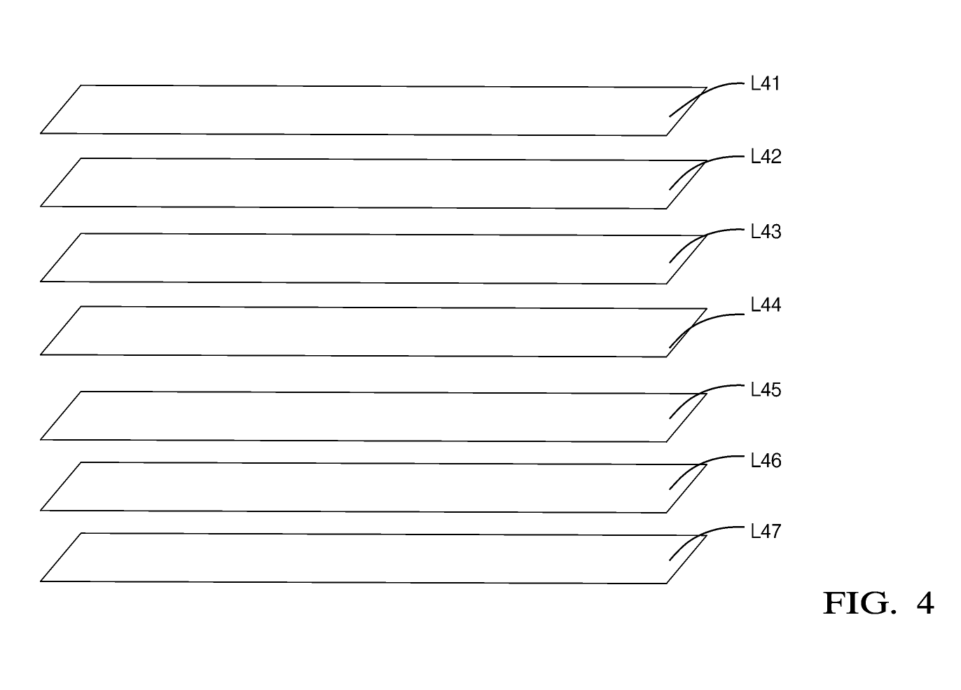

FIG. 4 is configured similarly to the embodiment shown in FIG. 3, except that the central layer structure has a single alumina insulating layer L44 and the first layer structure is present, having a single alumina insulating layer L43, L45 disposed on each side of the central layer structure. The rest of the element is similar to that shown in FIG. 3, with a second layer structure having a single zirconia layer L42, L46 disposed on each layer of the first layer structure, third and fourth layer structures not present, and alumina protective layers L41 and L47 disposed on each layer of the second layer structure. Each of layers L41 through L46 has an identical thickness of 172 micrometers. In one exemplary embodiment when used as an oxygen sensor, the element of FIG. 4 would have a sensing electrode on top of layer L42, a reference electrode between layers L42 and L43, a heater element between layers L44 and L45, and optionally an EM shield between layers L43 and L44.

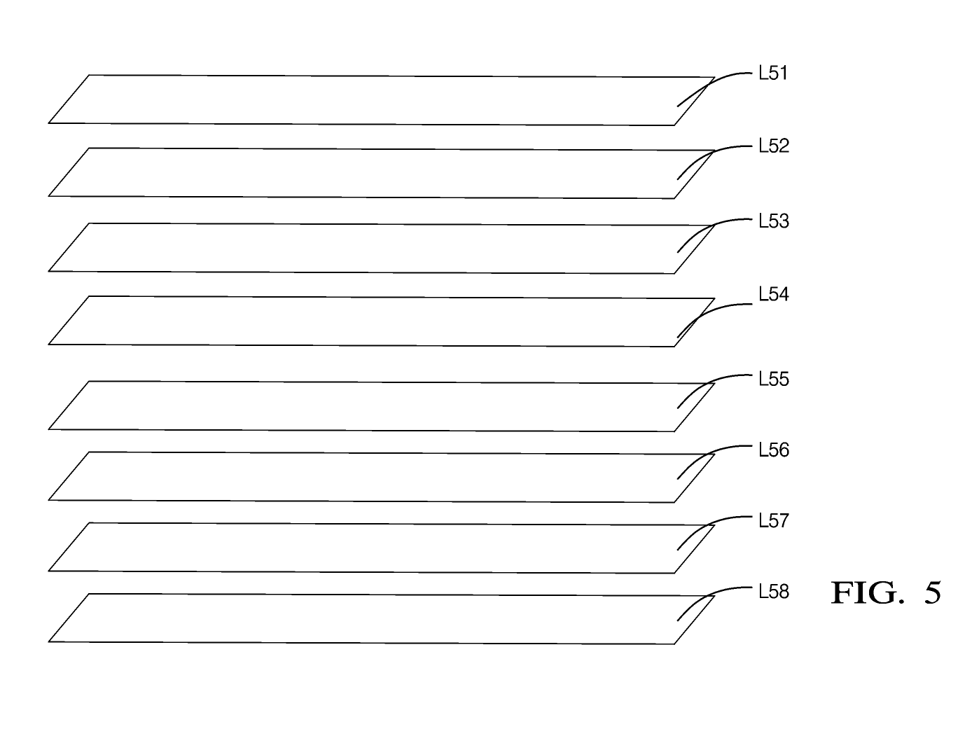

FIG. 5 is configured similarly to the embodiment shown in FIG. 3, except that the second layer structure has two alumina zirconia layers L52, L53, L56, L57 disposed on each side of the central layer structure. The rest of the element is similar to that shown in FIG. 3, with a central layer structure having two alumina insulating layers L54, L55, first, third and fourth layer structures not present, and alumina protective layers L51 and L58 disposed on each layer of the second layer structure. Each of layers L51 through L58 has an identical thickness of 172 micrometers. In one exemplary embodiment when used as a wide-range oxygen sensor, the element of FIG. 5 would have an outer sensing electrode on top of layer L52, an inner sensing electrode and an outer reference electrode separated by a chamber between layers L52 and L53, a reference electrode between layers L53 and L54, and a heater element between layers L54 and L55.

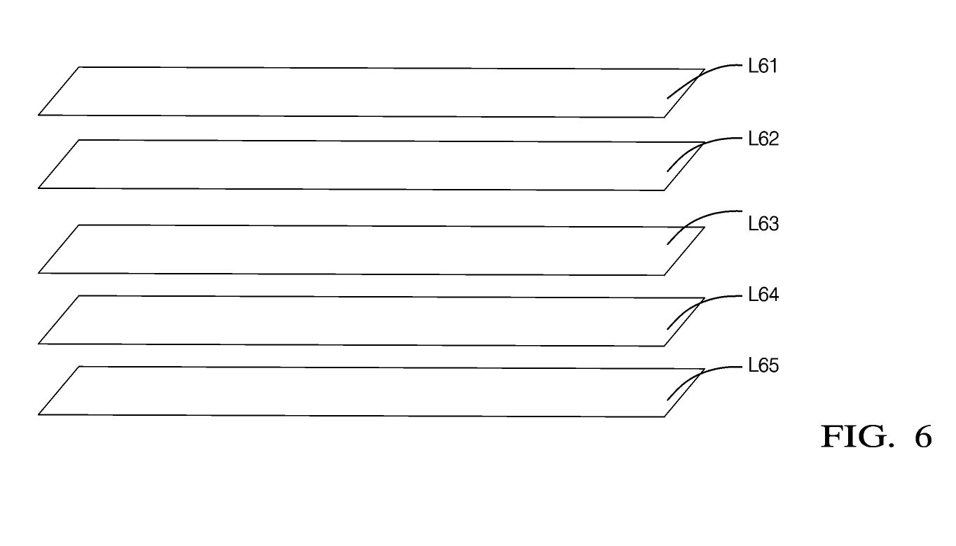

Turning now to FIG. 6, there is shown an exploded perspective view of an exemplary embodiment of a layer structure according to the invention having a central layer structure with a single alumina insulating layer L63, a second layer structure having a single zirconia layer L62, L64 disposed on each side of the central layer structure, first, third and fourth layer structures not present, and alumina protective layers L61 and L65 disposed on each layer of the second layer structure. Each of the layers L61-L65 has an identical cured layer thickness of 172 micrometers.

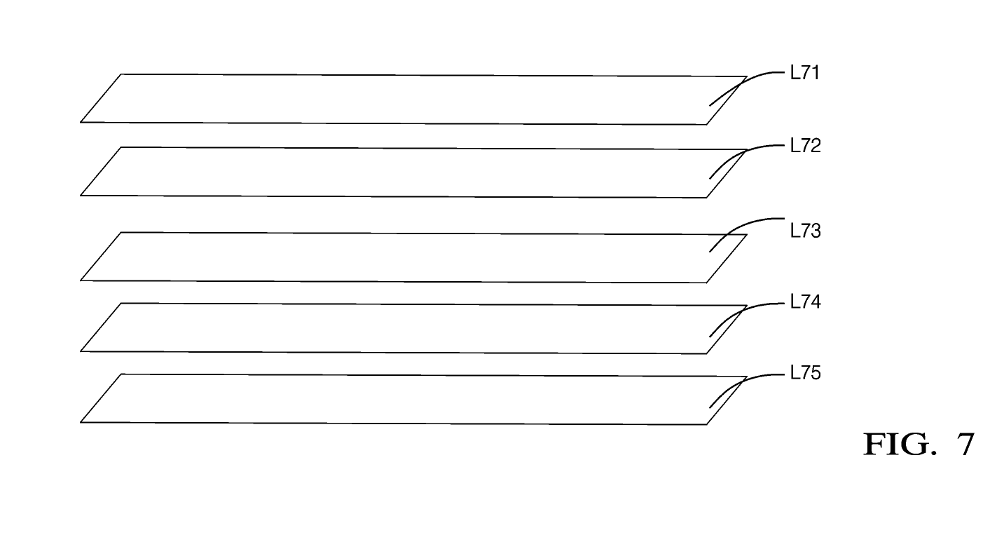

Turning now to FIG. 7, there is shown an exploded perspective view of an exemplary embodiment of a layer structure according to the invention having a central layer structure with a single zirconia layer L63, a second layer structure having a single alumina insulating layer L72, L74 disposed on each side of the central layer structure, first, third and fourth layer structures not present, and alumina protective layers L71 and L75 disposed on each layer of the second layer structure. Each of the layers L71-L75 has an identical cured layer thickness of 172 micrometers

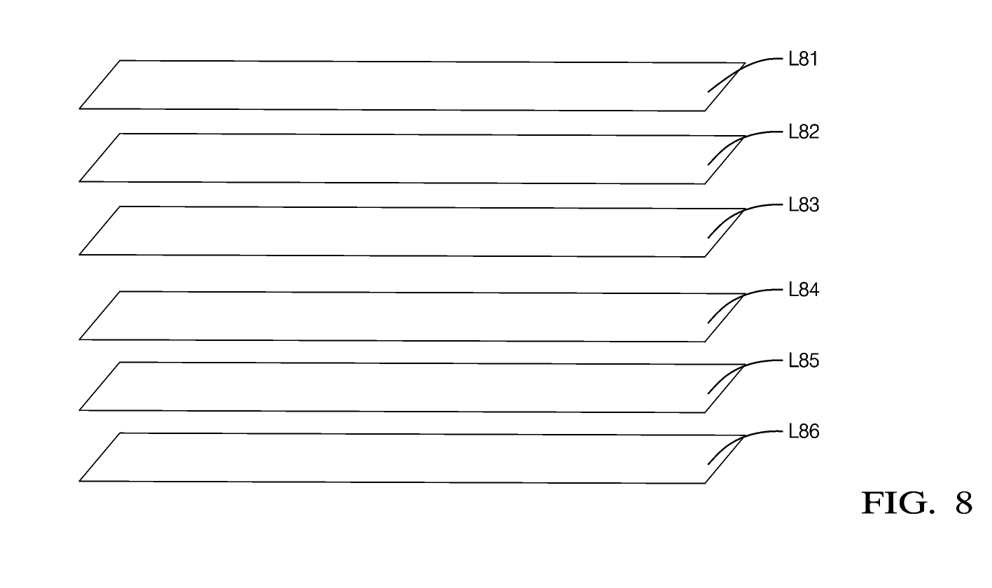

Turning now to FIG. 8, there is shown an exploded perspective view of an exemplary embodiment of a layer structure according to the invention having a central layer structure with two zirconia insulating layer L83, L84, a second layer structure having a single alumina insulating layer L82, L85 disposed on each side of the central layer structure, first, third and fourth layer structures not present, and alumina protective layers L81 and L86 disposed on each layer of the second layer structure. Each of the layers L81-L86 has an identical cured layer thickness of 172 micrometers

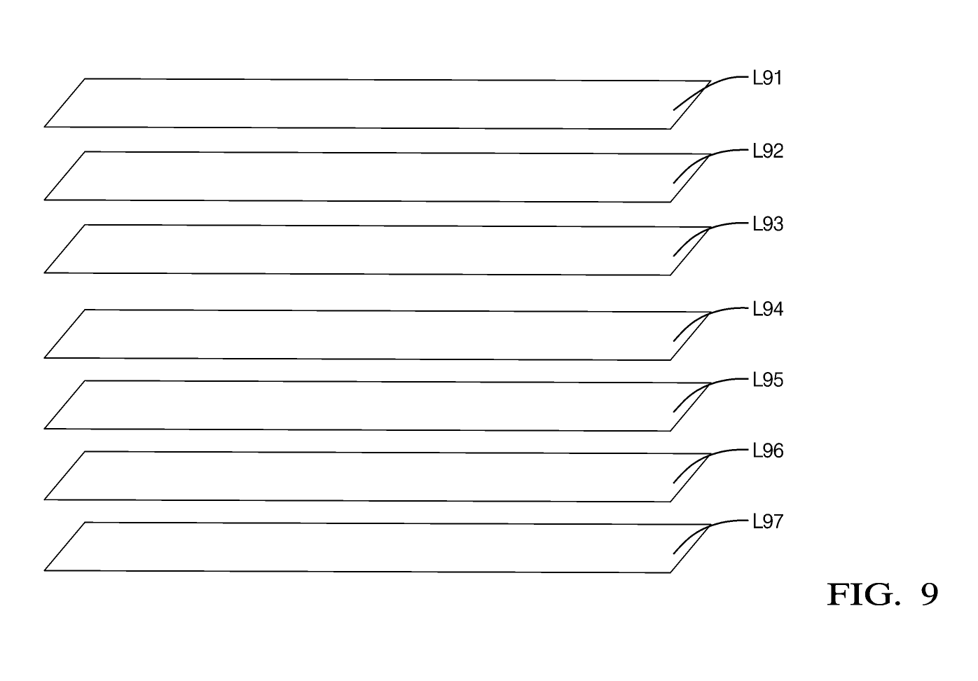

Turning now to FIG. 9, there is shown an exploded perspective view of an exemplary embodiment of a layer structure according to the invention having a central layer structure with a single alumina insulating layer L94, a second layer structure having a single zirconia layer L93, L95 disposed on each side of the central layer structure, a third layer structure having a single alumina insulating layer L92, L96 disposed on each layer of the second layer structure, third and fourth layer structures not present, and alumina protective layers L91 and L97 disposed on each layer of the third layer structure. Each of the layers L91-L97 has an identical cured layer thickness of 172 micrometers

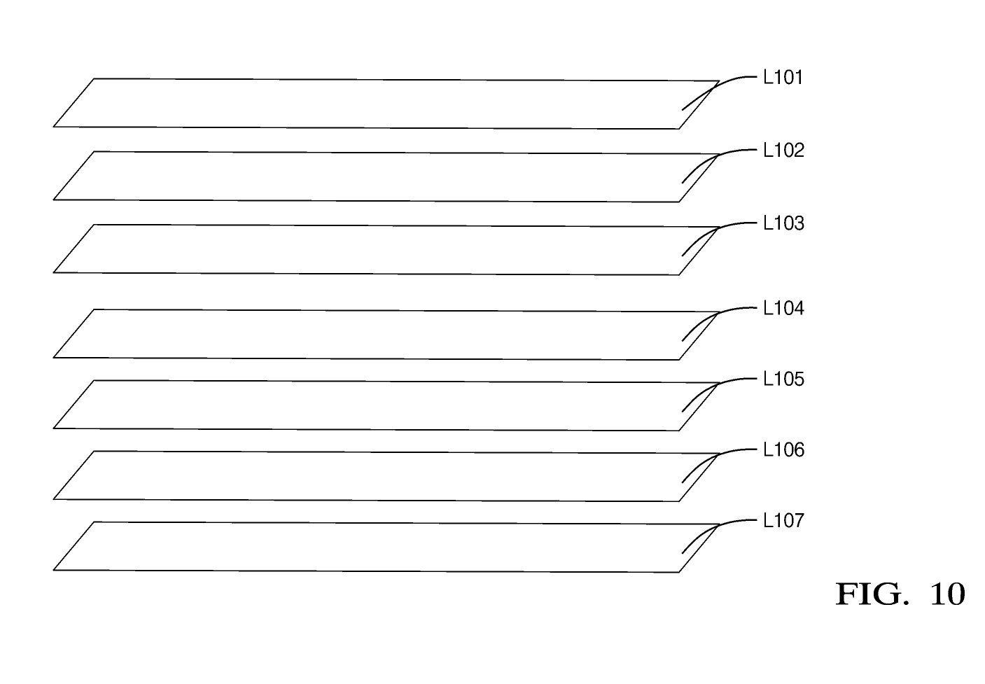

Turning now to FIG. 10, there is shown an exploded perspective view of an exemplary embodiment of a layer structure according to the invention having a central layer structure with a single zirconia layer L104, a second layer structure having two alumina insulating layers L102, L103, L105, L106 disposed on each side of the central layer structure, first, third, and fourth layer structures not present, and alumina protective layers L101 and L107 disposed on each layer of the second layer structure. Each of the layers L101-L107 has an identical cured layer thickness of 172 micrometers

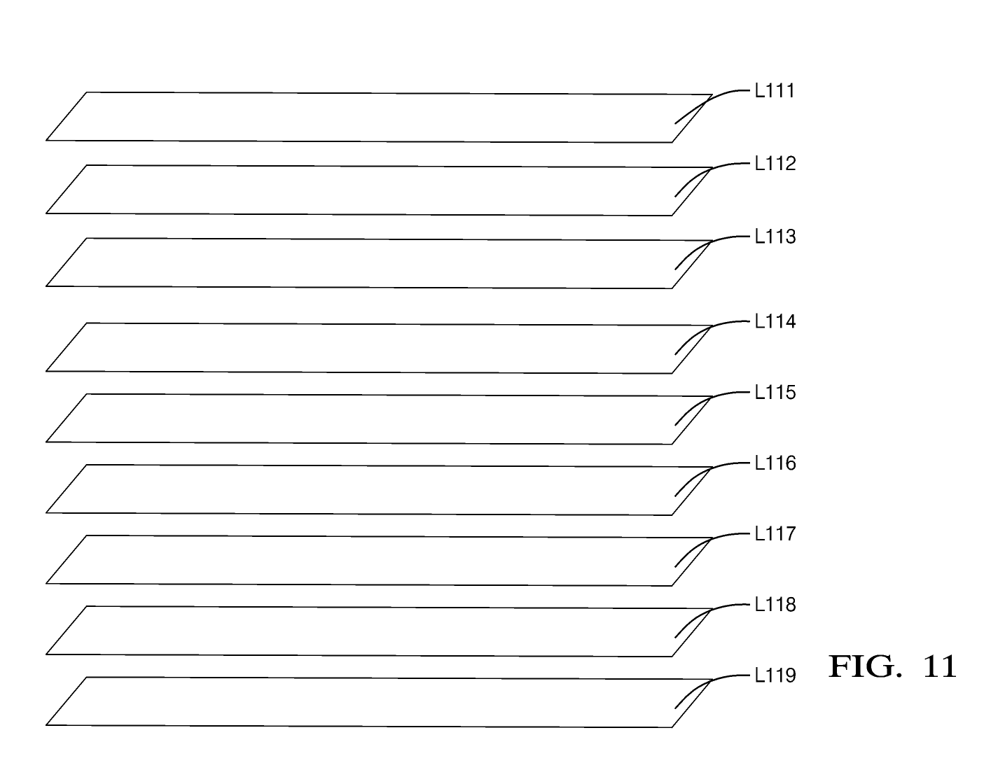

Turning now to FIG. 11, there is shown an exploded perspective view of an exemplary embodiment of a layer structure according to the invention having a central layer structure with two zirconia layers L114 and L115, a second layer structure having a single alumina insulating layer L113, L116 disposed on each side of the central layer structure, a third layer structure having a single zirconia layer L112, L117 disposed on each layer of the second layer structure, a fourth layer structure having a single alumina insulating layer L111, L118 disposed on each layer of the third layer structure, the first layer structure not present, and alumina protective layers L110 and L119 disposed on each layer of the fourth layer structure. Each of the layers L110-L119 has an identical cured layer thickness of 172 micrometers. In an alternate exemplary embodiment, layers L111 and L118 each has a cured thickness of 86 μm while layers L110, L119, and L112 through LL117 each has a cured thickness of 172 μm.

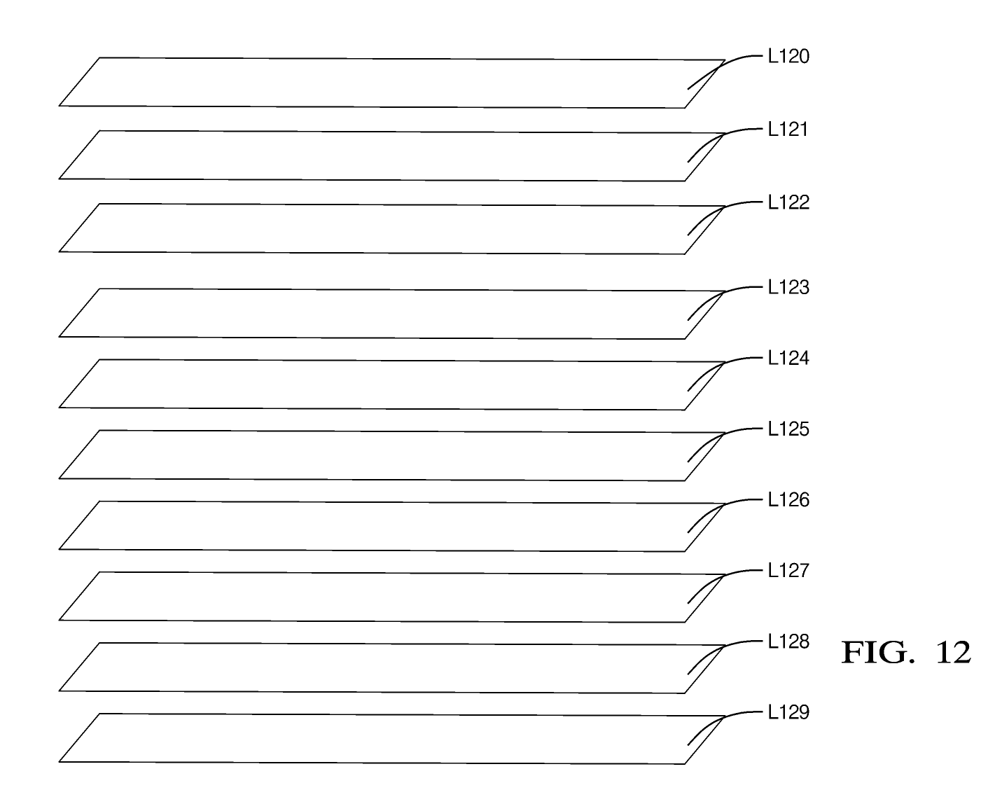

Turning now to FIG. 12, there is shown an exploded perspective view of an exemplary embodiment of a layer structure according to the invention having a central layer structure with two alumina insulating layers L124 and L125, a second layer structure having two zirconia layers L122, L123, L126, L127 disposed on each side of the central layer structure, a third layer structure having a single alumina insulating layer L121, L128 disposed on each layer of the second layer structure, first and fourth layer structures not present, and alumina protective layers L120 and L129 disposed on each layer of the third layer structure. Each of the layers L120-L129 has an identical cured layer thickness of 172 micrometers.

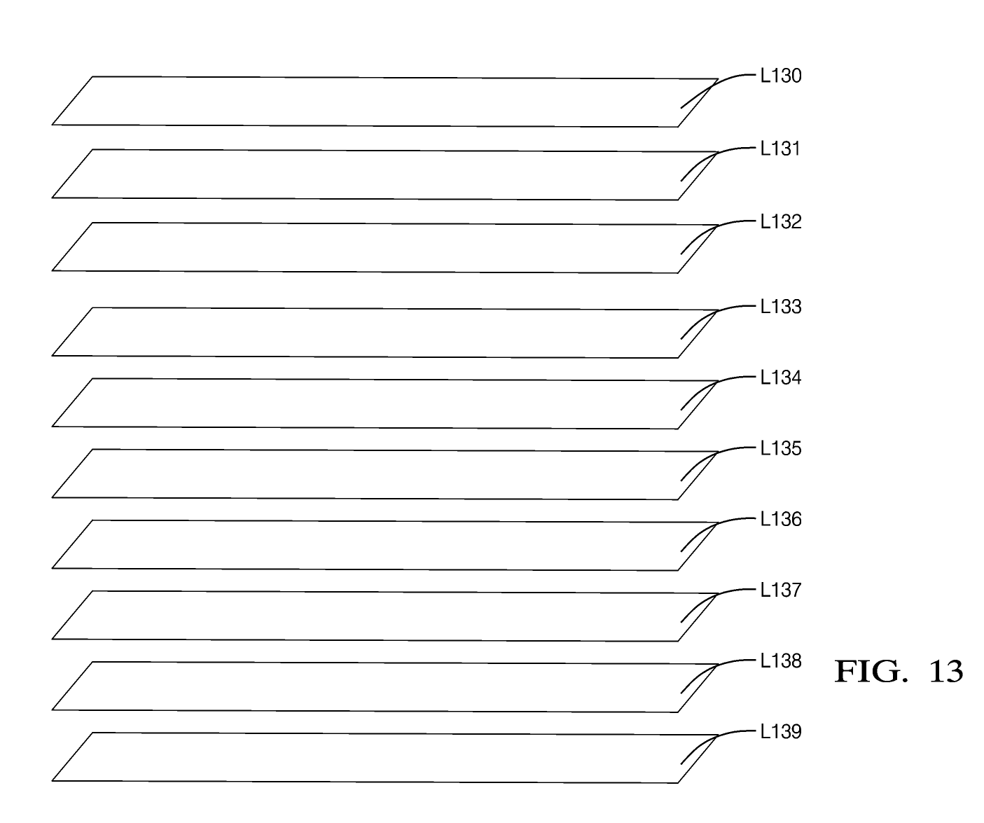

Turning now to FIG. 13, there is shown an exploded perspective view of an exemplary embodiment of a layer structure according to the invention having a central layer structure with two zirconia layers L134 and L135, a second layer structure having two alumina insulating layers L132, L133, L136, L137 disposed on each side of the central layer structure, a third layer structure having a single zirconia layer L131, L138 disposed on each layer of the second layer structure, first and fourth layer structures not present, and alumina protective layers L130 and L139 disposed on each layer of the third layer structure. Each of the layers L130-L139 has an identical cured layer thickness of 172 micrometers.

One of the features of the present invention is that the layers in each of the layer structures are described as having a predetermined thickness. In an exemplary non-limiting embodiment of the invention, Since the layers of each layer structure are symmetrically disposed on each side of the element, this ensures that the thickness of certain layer structure's layer that is disposed on one side of the element will have substantially the same thickness as that layer structure's corresponding layer disposed on the opposite of the element. Also, the characterization of the layer structure as being symmetrically disposed on each side of the element also ensures that a zirconia layer on one side of the element will be matched with a zirconia layer on the opposite side of the element, and likewise for the alumina layers. In an exemplary non-limiting embodiment of the invention, each layer will have substantially the same composition as matching layer on the opposite side of the element. In another exemplary non-limiting embodiment of the invention, each layer will have the identical composition as matching layer on the opposite side of the element, and more particularly will be from the same production ceramic green tape production batch. The thicknesses of the individual layers within a layer structure may vary as long as the thickness of each layer is symmetrically matched by the thickness a corresponding layer on the opposite side of the element, and of course the thickness of individual layers may vary from one layer structure to another layer structure. Representative layer thicknesses of 172 micrometers (6.8 mils) and 102 micrometers (4 mils) have been described above in FIGS. 1-13; however, it is understood that varying cured ceramic layer thicknesses may be employed as is known in the art, for example from 25 micrometers to 500 micrometers in one exemplary embodiment and from 50 micrometers to 200 micrometers in another exemplary embodiment.

The advantages of the invention are readily apparent when the sensor element is made by bulk ceramic technology where layers green ceramic sheets or tapes of ceramic material are laid together along with electrodes, fugitive materials, and other components deposited on the ceramic sheets or tapes by known methods, e.g., ink deposition methods (screen printing), vapor deposition, etc. The sandwiched layers of green ceramic sheets or tapes are then sintered at temperatures of about 1400° C. to about 1500° C. to fire the element.

The zirconia layers are capable of permitting the electrochemical transfer of oxygen ions, although each zirconia layer used in elements of the invention is not necessarily used as a solid electrolyte for that purpose. The zirconia layers described herein may be optionally stabilized with calcium, barium, yttrium, magnesium, aluminum, lanthanum, cesium, gadolinium, and the like as is known in the art.

After completion of the manufacture of the sensor element, the sintered sensor element may be disposed in a housing or package to form the completed sensor. Such a sensor may comprise the sintered sensor element, an upper housing shell, a lower housing shell, and a shield for the sensing element. The shield has opening(s) to enable fluid communication between the sensing end of the sensor element and the gas to be sensed. To provide structural integrity to the sensor element 38, insulators (e.g., ceramic, talc, mesh (metal or other), and/or the like) may be disposed between the sensor element and the shell. The terminal end of the sensor within the upper shell in electrical commutation with a terminal interface such that cables can be disposed in electrical communication with the sensor via the contact pads. During operation, the sensor is disposed in an area where a gas is to be sensed (e.g., within an exhaust conduit of a vehicle). When a gas passes down the conduit, the gas enters the sensor through shield openings and contacts the sensor element. The output signal(s) of the sensor are transmitted through the contact pads through electric cables to a signal processor and/or microprocessor controller that is in operable communication with a vehicle. Based upon the output of the sensor, vehicle operating parameters may be adjusted.

### EXAMPLES

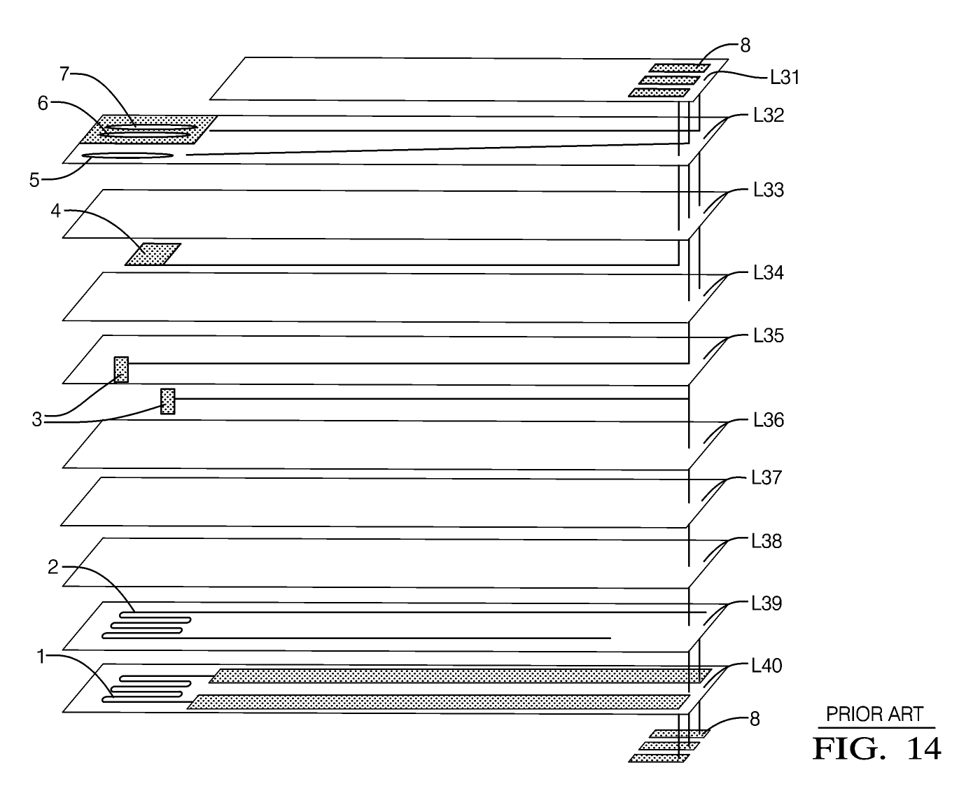

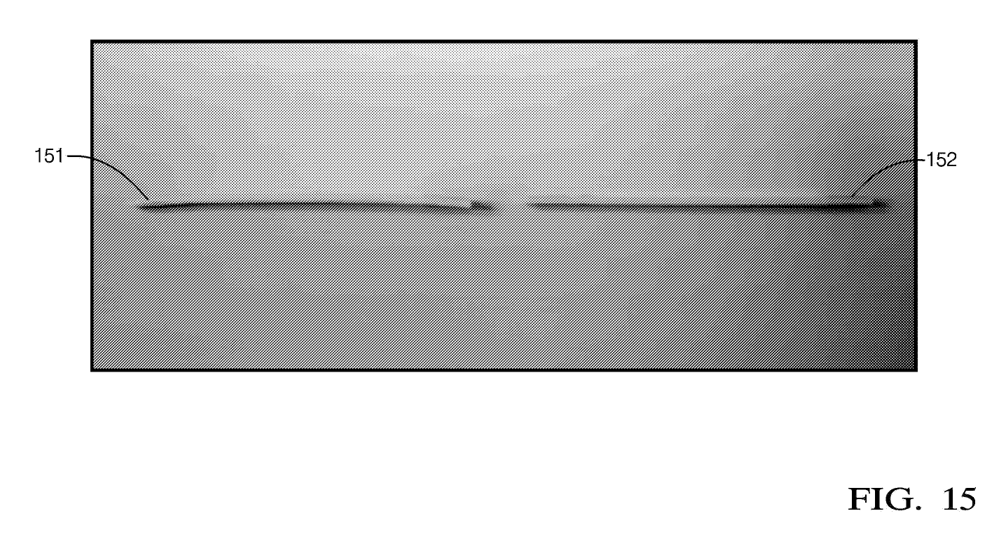

Sensor elements with the structures shown in FIGS. 14 and 2 were prepared from tape and ink raw materials. For each design, the appropriate number and thickness of tape cast alumina and zirconia tapes were blanked into sheets sized for producing seven elements in an array pattern. Via holes and electrode holes were punched into the sheet layers. The conductive circuits were applied to the sheets by screen printing platinum inks onto them. Fugitive carbon inks were printed for forming the chamber and channel features. For each design, the sheets were stacked in the correct order and orientation on a metal plate, sealed in an evacuated plastic bag, and laminated together in an isostatic laminator. Individual green ceramic elements were cut from the laminated tiles using a hot-knife. The organic binder and fugitive carbon material were burned away during a controlled temperature ramp up to a 120 minute hold at a sintering temperature of 1435° C. in a high temperature kiln. FIG. 15 shows an edge view photograph of the resulting two types of sintered elements with the element 152 according to the invention (FIG. 2) on the right and the comparison element 151 (FIG. 14) on the left. The comparison element 151 was warped and could not be assembled for sensor testing. The element 152 according to the invention was flat within acceptable tolerances.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing.

Having thus described the invention, it is claimed:

1. A flat ceramic exhaust gas sensor comprising a ceramic layer structure including one or more solid electrolyte layers, one or more insulating layers, and two or more electrodes, wherein the ceramic layer structure has:
(a) a flat central layer structure having a top side and a bottom side, said central layer structure selected from the group consisting of
(1) a single alumina insulating layer;
(2) two alumina insulating layers of equal thickness;
(3) a single zirconia layer; and
(4) two zirconia layers of equal thickness;
(b) on each of said sides of said central layer structure, in order:
(1) optionally, a first layer structure having a first predetermined thickness, selected from the group consisting of:
(i) one or more zirconia layers if said central layer structure is one or two zirconia layers;
(ii) one or more alumina insulating layers if said central layer structure is one or two alumina insulating layers;
(2) a second layer structure having a second predetermined thickness, selected from the group consisting of:
(i) one or more zirconia layers if said central layer structure is one or two alumina insulating layers, and
(ii) one or more alumina insulating layers if said central layer structure is one or two zirconia layers;
(3) optionally, a third layer structure having a third predetermined thickness, selected from the group consisting of:
(i) one or more alumina insulating layers if the second layer structure (b)(1) is one or more zirconia layers; and
(ii) one or more zirconia layers if the second layer structure (b)(1) is one or more alumina insulating layers;
(3) if said third layer structure is present and is one or more zirconia layers, then optionally, a fourth layer structure having a fourth predetermined thickness, comprising one or more alumina insulating layers; and
(4) an alumina protective layer having a fifth predetermined thickness.

2. An exhaust gas sensor according to claim 1 wherein said central layer structure has one or two zirconia layers.

3. An exhaust gas sensor according to claim 2 wherein said first layer is not present and said second layer structure has one alumina insulating layer.

4. An exhaust gas sensor according to claim 2 wherein said third layer structure is present with one or more zirconia layers.

5. An exhaust gas sensor according to claim 4 wherein said fourth layer structure is present and has one alumina insulating layer.

6. An exhaust gas sensor according to claim 5 wherein the fourth layer structure disposed over the top side of said central layer structure includes an ammonia sensing electrode.

7. An exhaust gas sensor electrode according to claim 6 wherein the fourth layer structure disposed over the top side of said central layer structure further includes a NOₓ sensing electrode, said third layer structure disposed over the top side of said central layer structure includes a reference electrode, said central layer structure includes an impedence electrode, said fourth layer structure disposed over the bottom side of said central layer structure includes an electromagnetic radiation shield, and said protective layer disposed over the bottom side of said central layer structure includes a heater element.

8. An exhaust gas sensor according to claim 2 wherein said third and fourth layer structures are not present.

9. An exhaust gas sensor according to claim 1 wherein said central layer structure has two alumina insulating layers.

10. An exhaust gas sensor according to claim 9 wherein said first layer structure is not present and second layer structure has one or two zirconia layers.

11. An exhaust sensor according to claim 10 wherein said second layer structure has two zirconia layers.

12. An exhaust gas sensor according to claim 11 wherein said third and fourth layer structures are not present.

13. An exhaust gas sensor according to claim 12, further comprising an outer oxygen-sensing electrode disposed over the uppermost layer of the second layer structure disposed over the top side of said central layer structure, an inner oxygen-sensing electrode and an outer reference electrode disposed between the two layers of the second layer structure disposed over the top side of said central layer structure and separated by a chamber, an inner reference electrode disposed between the lowermost layer of the second layer structure disposed over the top side of said central and the uppermost layer of the central layer structure, and a heater.

14. An exhaust sensor according to claim 10 wherein said second layer structure has one zirconia layer.

15. An exhaust gas sensor according to claim 14 wherein said third and fourth layer structures are not present.

16. An exhaust gas sensor according to claim 15, further comprising an oxygen-sensing electrode dispose on top of the second layer structure disposed over the top side of the central layer structure, a reference electrode disposed between the second layer structure disposed over the top side of the central layer structure and the uppermost layer of the central layer structure, and a heater element disposed between the two layers of the central layer structure.

17. An exhaust gas sensor according to claim 1 wherein said central layer structure has one alumina insulating layer and said first layer structure has one alumina insulating layer.

18. An exhaust gas sensor according to claim 17 wherein said second layer structure layer is present and has one alumina insulating layer.

19. An exhaust gas sensor according to claim 18 wherein said third and fourth layer structures are not present.

20. An exhaust gas sensor according to claim 19, further comprising an oxygen-sensing electrode dispose on top of the second layer structure disposed over the top side of the central layer structure, a reference electrode disposed between the second layer structure disposed over the top side of the central layer structure and the first layer structure disposed over the top side of the central layer structure, and a heater element disposed between the central layer structure and the first layer structure disposed over the bottom side of the central layer structure.
